(19) United States
(12) Patent Application Publication
(10) Pub. No.: US 2022/0186070 A1
(43) Pub. Date: Jun. 16, 2022

(54) MULTI-FUNCTIONAL POLYURETHANE COATINGS

(71) Applicant: Hewlett-Packard Development Company, L.P., Spring, TX (US)

(72) Inventors: Zhang-Lin ZHOU, San Diego, CA (US); Xiaoqi ZHOU, San Diego, CA (US)

(73) Assignee: Hewlett-Packard Development Company, L.P., Spring, TX (US)

(21) Appl. No.: 17/433,132

(22) PCT Filed: Oct. 18, 2019
(86) PCT No.: PCT/US2019/056912

§ 371 Date: Aug. 23, 2021

(51) Int. Cl. C09D 175/08; C08G 18/75; C08G 18/48; C08G 18/38; C08G 18/08; C08G 18/10; D06P 1/52; B41M 5/52; D06N 3/14

(52) U.S. Cl. CPC C09D 175/08; C08G 18/755; C08G 18/4833; C08G 18/388; D06N 3/141; C08G 18/10; D06P 1/5285; B41M 5/5281; C08G 18/0866

(57) ABSTRACT

A multi-functional polyurethane coating composition can include water and polyurethane particles including a blend of polyurethane polymers with polyurethane backbones. The polyurethane particles can include multiple pendant groups independently attached to one or multiple polyurethane backbones within the blend of polyurethane polymers. The multiple pendant groups of the polyurethane particles include polyalkylene oxides, aliphatic phosphonium salts, and epoxides.

### BACKGROUND

Inkjet printing has become a popular way of recording images on various media. Some of the reasons include low printer noise, variable content recording, capability of high-speed recording, and multi-color recording. These advantages can be obtained at a relatively low price to consumers. As the popularity of inkjet printing increases, the types of use also increase providing demand for new print media, for example.

### BRIEF DESCRIPTION OF DRAWINGS

FIG. 1 schematically illustrates an example multi-functional polyurethane coating composition for coating print media substrates in accordance with the present disclosure;

FIG. 2 schematically illustrates an example multi-functional polyurethane coated print media in accordance with the present disclosure;

FIG. 3 provides a flow diagram for an example method of making multi-functional polyurethane coated print media in accordance with the present disclosure; and

FIGS. 4-7 show schematic example portions of example polyurethane polymers that can be used to form polyurethane particles for inclusion in multi-functional polyurethane coating compositions and multi-functional polyurethane coated print media in accordance with the present disclosure.

### DETAILED DESCRIPTION

The present technology relates to multi-functional polyurethane coating compositions for print media, multi-functional polyurethane coated print media, and methods for making print media. These coating compositions can be applied to media substrates to form print media having multiple functions, including added flame retardance, good water dispersibility, the ability to crosslink with other polymers and in some instances, print media substrates, and the like. For example, the presence of the polyalkylene oxide either as end caps or as side chains along the polyurethane backbone can contribute to the water dispersibility of the polyurethane particles. The presence of aliphatic phosphonium salts as end caps or as side chains along the polyurethane backbone can provide enhanced flame-retardant properties. The presence of the epoxide group at an endcap or along the polyurethane backbone can provide a crosslinkable moiety that can crosslink with other polymers, such as polyamines, for example.

Thus, in one example, a multi-functional polyurethane coating composition includes water and polyurethane particles including a blend of polyurethane polymers with polyurethane backbones. The polyurethane particles in this example include multiple pendant groups independently attached to one or multiple polyurethane backbones within the blend of polyurethane polymers, wherein the multiple pendant groups of the polyurethane particles include polyalkylene oxide, aliphatic phosphonium salt, and epoxide. In one example, the epoxide can be an alcohol-based glycidyl ether or amine, e.g., glycerol diglycidyl ether. In another example, the epoxide can be included on one or multiple polyurethane backbones as an end cap group. In other specific examples, the aliphatic phosphonium salt can be included on one or multiple polyurethane backbones as an end cap group, and/or can be included on one or multiple polyurethane backbones as a side chain group. In another specific example, the polyalkylene oxide can be included on one or multiple polyurethane backbones as a side chain group. The polyalkylene oxide can be, for example, a polyethylene oxide, a polypropylene oxide, or a combination of polyethylene oxide and polypropylene oxide. In another example, one or multiple polyurethane backbones of the polyurethane blend can include polymeric portions that bridge urethane linkage groups. The polymeric portions can be formed from copolymerized polymeric polyols including: polyether polymer polyols, polyester polymer polyols, polycarbonate polymer polyols, or a combination thereof. In further detail, the urethane linkage groups can be formed by reacting polymeric polyols with 2,2,4-trimethylhexane-1,6-diisocyanate; 2,4,4-trimethylhexane-1,6-diisocyanate; hexamethylene diisocyanate; methylene diphenyl diisocyanate; isophorone diisocyanate; 1-Isocyanato-4-[(4-isocyanatocyclohexyl)methyl]cyclohexan; or a combination thereof.

In another example, a coated print medium includes a print media substrate and an ink-receiving layer on the print media substrate. The ink-receiving layer in this example includes polyurethane particles including a blend of polyurethane polymers with polyurethane backbones, wherein the polyurethane particles include multiple pendant groups independently attached to one or multiple polyurethane backbones within the blend of polyurethane polymers. The multiple pendant groups of the polyurethane particles in this example include polyalkylene oxides, aliphatic phosphonium salts, and epoxides. In one example, the epoxides can be included on one or multiple polyurethane backbones as end cap groups; the aliphatic phosphonium salts can be included on one or multiple polyurethane backbones as end cap groups, as side chain groups, or both end cap groups and side chain groups; and the polyalkylene oxides can be included on one or multiple polyurethane backbones as side chain groups. The ink-receiving layer in some examples can further include a second polymer with a functional group reactive the epoxides to open the epoxides upon application of heat, e.g., from 80° C. to 200° C., but which may also be stable in the presence of the epoxide at temperatures from 0° C. to 50° C. In further detail, in one example, the print media substrate can be a fabric substrate.

In another example, a method of making a coated print medium includes applying a multi-functional polyurethane coating composition as a layer to a print media substrate, the multi-functional polyurethane coating composition including water and polyurethane particles including a blend of polyurethane polymers with polyurethane backbones. The polyurethane particles in this example include multiple pendant groups independently attached to one or multiple polyurethane backbones within the blend of polyurethane polymers. The multiple pendant groups of the polyurethane particles include polyalkylene oxides, aliphatic phosphonium salts, and epoxides. The method further includes drying the multi-functional polyurethane coating composition to remove water therefrom on the print media substrate to leave an ink-receiving layer thereon. In one specific example, one or multiple polyurethane backbones of the polyurethane blend can include polymeric portions that bridge urethane linkage groups, and the urethane linkage groups can be formed by reacting a polyol of the polymeric portions with 2,2,4-trimethylhexane-1,6-diisocyanate; 2,4,4-trimethylhexane-1,6-diisocyanate; hexamethylene diisocyanate; methylene diphenyl diisocyanate; isophorone diisocyanate; 1-Isocyanato-4-[(4-isocyanatocyclohexyl)methyl]cyclohexan; or a combination thereof.

It is noted that when discussing the multi-functional polyurethane coating compositions, multi-functional polyurethane coated print media, and methods of making multi-functional polyurethane coated print media, these discussions can be considered applicable to one another whether or not they are explicitly discussed in the context of that example. Thus, for example, when discussing polyurethane backbones related to the multi-functional polyurethane coating compositions, such disclosure is also relevant to and directly supported in the context of the coated print media and methods of making coated print media, and vice versa. It is also understood that terms used herein will take on their ordinary meaning in the relevant technical field unless specified otherwise. In some instances, there are terms defined more specifically throughout the specification or included at the end of the present specification, and thus, these terms have a meaning as described herein.

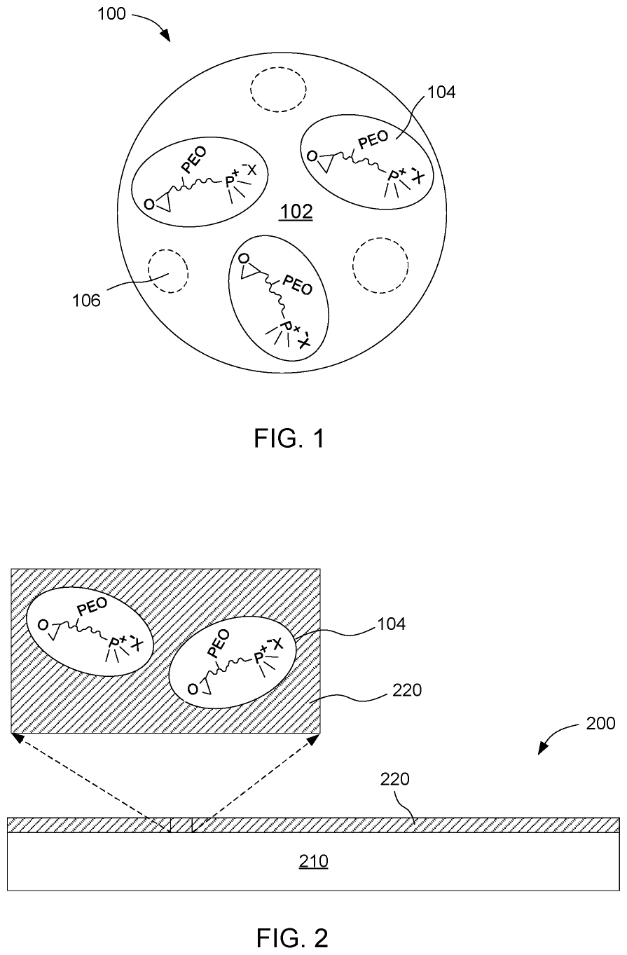

Turning now to more specific detail regarding the multi-functional polyurethane coating compositions, as shown in FIG. 1, an example multi-functional polyurethane coating composition 100 can include liquid vehicle 102, which is an aqueous liquid vehicle including water and polyurethane particles 104 including polyurethane polymers with polyurethane backbones, one example of which is shown schematically in this FIG. and not by way of limitation. The polyurethane polymers can include polyalkylene oxide pendant groups, which can be in the form of a side chain or an end cap, aliphatic phosphonium salt groups, which can likewise be in the form of a side chain or an end cap, and an epoxide pendant group, which can be in the form of a side chain or an end cap. In the example shown, the polyalkylene oxide is shown schematically as abbreviated PEO, but it is noted that the polyalkylene oxide may be a polyethylene oxide, a polypropylene oxide, or include a combination polyethylene oxide and polypropylene oxide moieties. Also, in the example shown, a cationic “P” group is shown with multiple methyl groups, but it is understood that these may be short chain alkyl groups, such as from C1 to C5 branched or straight-chained alkyl. Also shown in this example, the epoxide is shown schematically as a closed heterocyclic three-membered ring with two carbons and one oxygen. However, the epoxide pendant group may likewise include a multiglycidyl group, such as glycerol glycidyl ether, for example. Other variations of these polyurethane backbone pendant groups (in the form of either end caps and/or side chains) can also be used, as described in greater detail hereinafter.

As a point of clarity, the term “pendant” or “pendant group” refers to functional groups that are attached to a polyurethane backbone, and include both side chain groups as well as end cap groups, as both types of groups are attached to the polyurethane backbone either directly or through a linkage group, such as a urethane linkage group or other type of linkage group that attaches the pendant group to the polyurethane backbone.

Furthermore, the term “multi-functional” when referring to the polyurethane particles or polyurethane strands indicates that there are multiple functional groups appended to the polyurethane backbone of one or multiple polyurethane polymers of the polyurethane particles. Thus, in examples of the present disclosure, there may be three chemically distinct pendant groups, e.g., polyalkylene oxides, aliphatic phosphonium salts, and epoxides, and these three chemically distinct pendant groups can be attached to the polyurethane backbone in one or both of two different ways, e.g., as side chains and/or end caps.

Referring again to FIG. 1, a dashed circle is included indicating that the multi-functional coating composition (or resulting ink-receiving layer) can further include other solids 106 dispersed therein, such as a second polymer resin, a cationic fixing agent (e.g., metal inorganic salt, metal organic salt, cationic polymer, etc.), inorganic particulate fillers, optical brightening agents (e.g., 4,4′-diamo-2,2′-stilbenedisulfonic acid, 4,4′-bis(benzoxazoyly-cis-stilbene, 2,5-bis(benzoxazole-2-yl)thiopene, etc.), and/or crosslinking agents. In the case of second polymer resins, they may be selected to be crosslinking agents, for example, so that when the multi-functional coating composition, when applied and dried on a media substrate as ink-receiving layer, is heated, crosslinking between the polyurethane polymers and the second polymer resin may occur, for example.

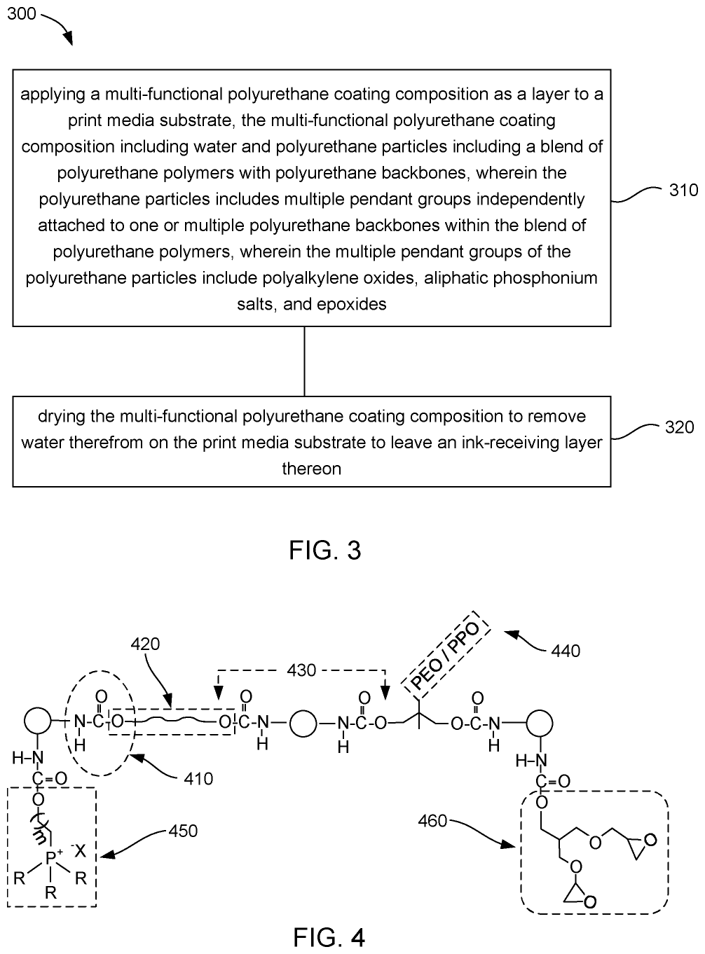

FIG. 2 provides an example multi-functional polyurethane print medium 200 with the multi-functional polyurethane coating composition of FIG. 1 having been applied to a print media substrate 210 and dried, leaving an ink-receiving layer 220 thereon. In one example, as shown in an enlarged view, the ink-receiving layer includes the polyurethane particles 104.

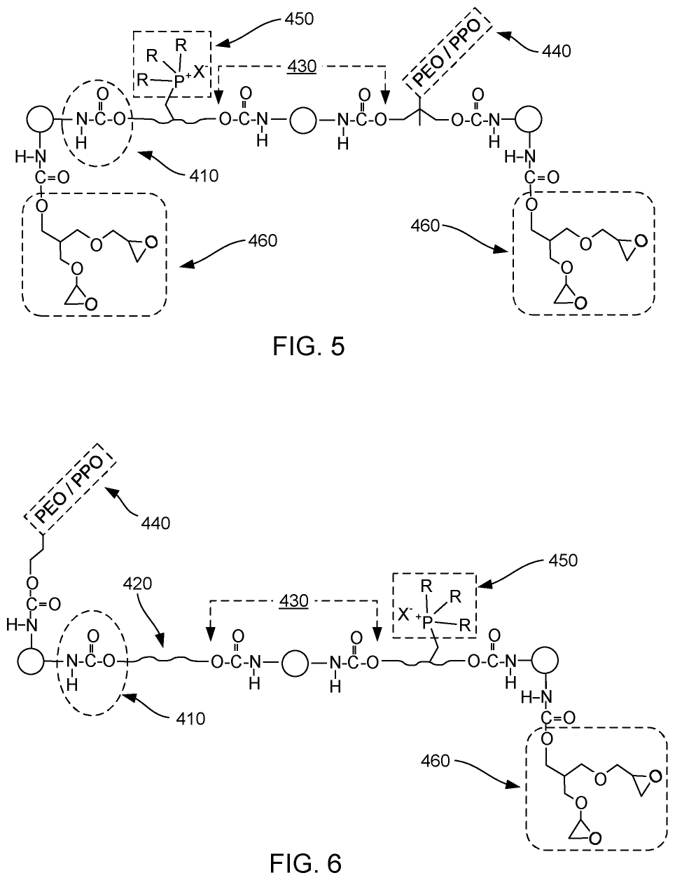

FIG. 3 depicts a method 300 of making a multi-functional polyurethane coated print medium can include applying 310 a multi-functional polyurethane coating composition as a layer to a print media substrate, the multi-functional polyurethane coating composition including water and polyurethane particles. The polyurethane particles in this example include a blend of polyurethane polymers with polyurethane backbones. The polyurethane particles can include multiple pendant groups independently attached to one or multiple polyurethane backbones within the blend of polyurethane polymers. The multiple pendant groups of the polyurethane particles can include polyalkylene oxides, aliphatic phosphonium salts, and epoxides. The method can also include drying the multi-functional polyurethane coating composition to remove water therefrom on the print media substrate to leave an ink-receiving layer thereon. In one specific example, one or multiple polyurethane backbones of the polyurethane blend include polymeric portions that bridge urethane linkage groups, and the urethane linkage groups can be formed by reacting a polyol of the polymeric portions with 2,2,4-trimethylhexane-1,6-diisocyanate; 2,4,4-trimethylhexane-1,6-diisocyanate; hexamethylene diisocyanate; methylene diphenyl diisocyanate; isophorone diisocyanate; 1-Isocyanato-4-[(4-isocyanatocyclohexyl)methyl]cyclohexane; or a combination thereof.

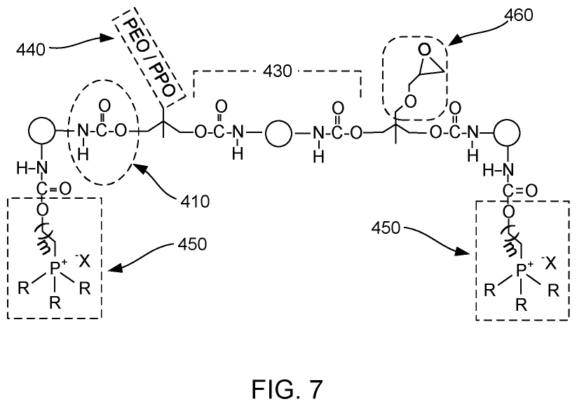

FIGS. 4-7 provide example schematic representations of portions of polyurethane particles that can be formed in accordance with the present disclosure. As an initial matter in regard to the example schematic structures shown in FIGS. 4-7, m can be from 1 to 18, from 1 to 14, from 1 to 10, from 2 to 18, from 2 to 10, from 1 to 5, or from 2 to 5, for example. R can independently be straight-chained or branched C1 to C5 or C2 to C5 alkyl, and X can be any counterion suitable for the positively charged phosphorus atom of the phosphonium salt end cap group, such as CI, Br, I, sulfonate, p-toluenesulfonate, trifluoromethanesulfonate, etc. The weight average molecular weight of the polyurethane polymers present in the polyurethane particles can be from 5,000 Mw to 500,000 Mw, from 10,000 Mw to 400,000 Mw, from 20,000 Mw to 250,000 Mw, from 10,000 Mw to 200,000 Mw, or from 50,000 Mw to 500,000 Mw, as measured by gel permeation chromatography, for example. Furthermore, these polyurethane particles included in the context of the present disclosure can have a D50 particle size from 20 nm to 500 nm, from 20 nm to 200 nm, from 40 nm to 400 nm, from 60 nm to 300 nm, or from 100 nm to 500 nm, for example. “D50” particle size is defined as the particle size at which about half of the particles are larger than the D50 particle size and about half of the other particles are smaller than the D50 particle size (by weight based on the particle content of the particles being sized). As used herein, particle size with respect to the polyurethane particles can be based on volume of the particle size normalized to a spherical shape for diameter measurement. Particle size information can also be determined and/or verified using a scanning electron microscope (SEM).

With further reference to FIGS. 4-7, several chemical moieties are schematically shown by way of example, including urethane linkage groups 410 (formed from isocyanate groups reacted with any of a number of polyols that may be present). For example, the polyols 420 are shown schematically after polymerization. These polyols can be in the form of polymeric diols or short chained diols that may include pendant polyalkylene oxides, pendant aliphatic phosphonium salts, pendant epoxides, etc., or other types of polyols. The polyols can be reacted with isocyanates to form the urethane linkage groups. In more specific detail, the urethane linkage groups along a backbone of the polyurethane polymer can be formed by reacting these or other polyols with diisocyanates, which are shown at 430 as a backbone group after reaction with hydroxyl groups of adjacent compounds. The diisocyanates, shown as polymerized along the polyurethane backbone, are schematically represented by a circle with isocyanate groups on either side thereof.

The three types of pendent groups that characterize the multi-functional polyurethanes described herein are shown in FIGS. 4-7 at various locations. Those three types of pendant groups are shown schematically as a polyalkylene oxide 440, an aliphatic phosphonium salt 450, and an epoxide 460. In these FIGS, “PEO” refers to polyethylene oxide, “PPO” refers to polypropylene oxide, and “PEO/PPO” indicates that the polyalkylene oxide can be polyethylene oxide, polypropylene oxide, or include both types of monomeric units as a hybrid polyalkylene.

In more specific detail, as shown in FIG. 4, the end caps in this example are in the form of the aliphatic phosphonium salt at one end and the epoxide at the other end. Specifically, the epoxide end cap in this example is a glycerol glycidyl ether. The polyalkylene oxides, on the other hand, are included as a side chain group. FIG. 5, on the other hand, by way of example, includes both end caps in the form of the epoxide groups, and the polyalkylene oxides and the aliphatic phosphonium salts are both included as side chain groups. The example of FIG. 6 includes the polyalkylene oxide and the epoxide as the two end caps on this particular polyurethane polymer strand, and the aliphatic phosphonium salt is included as a side chain group. FIG. 7 as another example includes two aliphatic phosphonium salts as the end caps, and the polyalkylene oxide and epoxide are included as side chain groups.

It is noted that the structures shown in FIGS. 4-7 are not intended to depict specific polymers, but rather show examples of the types of groups that may be present along the polyurethane backbone and/or end caps of the polyurethane particles or blends of polyurethane polymers present in a polyurethane particle. For example, there may be additional polymerized polymeric diols, polymerized isocyanates, urethane linkage groups, polyalkylene oxides, or even other moieties not shown in this example. For example, there may be small molecule diols, organic acid diols, C2-C20 aliphatic diols, functional amine groups derived from isocyanate groups that do not form a urethane linkage group, acid groups introduced from sulfonic acid or carboxylic acid diamines, or the like. These and other types of moieties can be included.

In more specific detail regarding the initial reactants that can be used to form the polyurethane particles of the present disclosure, there can be isocyanates that can be reacted with polymeric diols to form urethane linkage groups. There can also be aliphatic phosphonium salts included along the backbone, or along the backbone and as end cap groups, of the polyurethane polymer. Furthermore, in some examples, polyalkylene oxide moieties can be included at various locations, e.g., along the backbone or as end cap groups. Thus, these more specific components are described in greater detail hereinafter.

Example diisocyanates that can be used to prepare the prepolymer (used subsequently to form the polyurethane particles) include 2,2,4 (or 2, 4, 4)-trimethylhexane-1,6-diisocyanate (TMDI), hexamethylene diisocyanate (HDI), methylene diphenyl diisocyanate (MDI), isophorone diisocyanate (IPDI), and/or 1-Isocyanato-4-[(4-isocyanatocyclohexyl)methyl]cyclohexan (H12MDI), etc., or combinations thereof, as shown below. Others can likewise be used alone, or in combination with these diisocyanates, or in combination with other diisocyanates not shown.

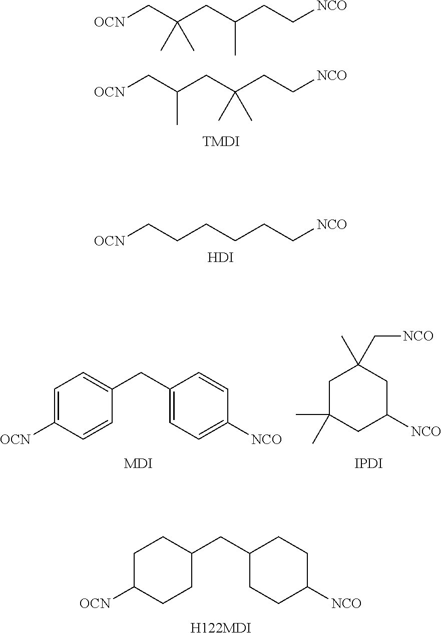

In further detail, to react with the isocyanates to form the urethane linkage groups, there can be mono-alcohols and polyols included. These alcohols can include the polyalkylene oxides, aliphatic phosphonium salts, and epoxides as previously described.

As mentioned, polyalkylene oxides can be included, for example, as pendant groups in the form of side chain groups or end cap groups. As mentioned, the polyalkylene oxides can include polyethylene oxide (PEO), polypropylene oxide (PPO), or a hybrid of both PEO and PPO, which includes both types of monomeric units as a hybrid polyalkylene. These polyalkylene oxides can be grafted or copolymerized during formation of a polyurethane prepolymer to provide polyalkylene oxide moieties along the backbone or can be added at the end by reacting them with end isocyanate groups to form polyalkylene oxide end cap groups. Either way the polyalkylene oxide moieties can have a number average molecular weight (Mn) from 200 Mn to 15,000 Mn, from 500 Mn to 15,000 Mn, from 1,000 Mn to 12,000 Mn, from 2,000 Mn to 10,000 Mn, or from 3,000 Mn to 8,000 Mn.

In further detail, the aliphatic phosphonium salts can be included, for example, as pendant groups in the form of side chain groups or end cap groups. In preparation for incorporating the aliphatic phosphonium salt into the polyurethane backbone of the polyurethane polymer, the aliphatic phosphonium salt can be prepared by the following reaction scheme (Equation 1), which provides a general method of making various aliphatic phosphonium salt-based diols. More specifically, the following is an example reaction of an alkyl phosphine (I) with a halogenated primary alcohol (II) at a high temperature, e.g., 100° C., to give a trialkylphosphonium salt-based alcohol (III).

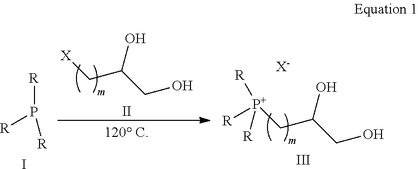

where R can independently be straight-chained or branched C1 to C5 or C2 to C5 alkyl; m can be from 1 to 18, from 1 to 14, from 1 to 10, from 2 to 18, from 2 to 10, from 1 to 5, or from 2 to 5; and X can be any suitable counterion for the positively charged phosphorus atom, such as bromide, chloride, or iodide, sulfonate, p-toluenesulfonate, trifluoromethanesulfonate, for example. Based on the general reaction scheme shown above as Equation 1, large numbers of example aliphatic phosphonium salt-based diols can be synthesized for inclusion as side chain pendant groups along the polyurethane backbone. In accordance with that shown in Equation 1, several example trialkylphosphonium salt-based diols can be formed, as shown below:

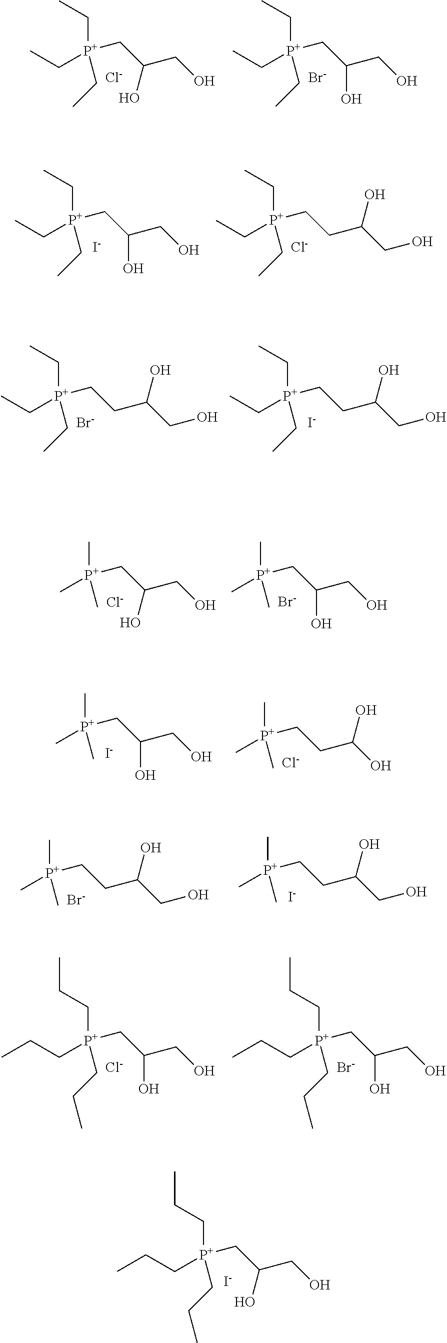

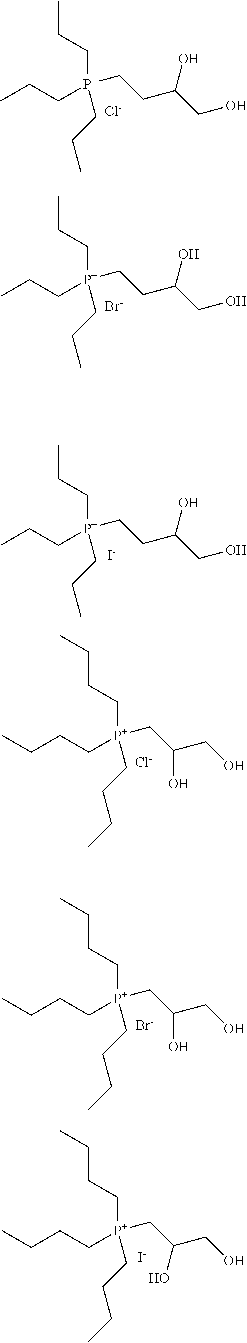

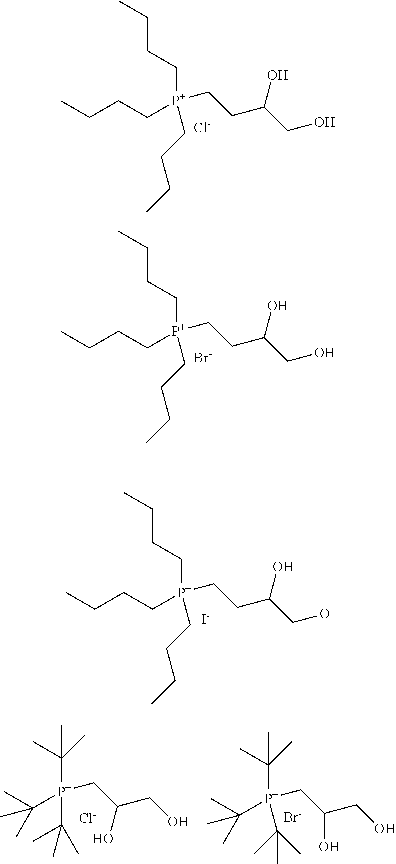

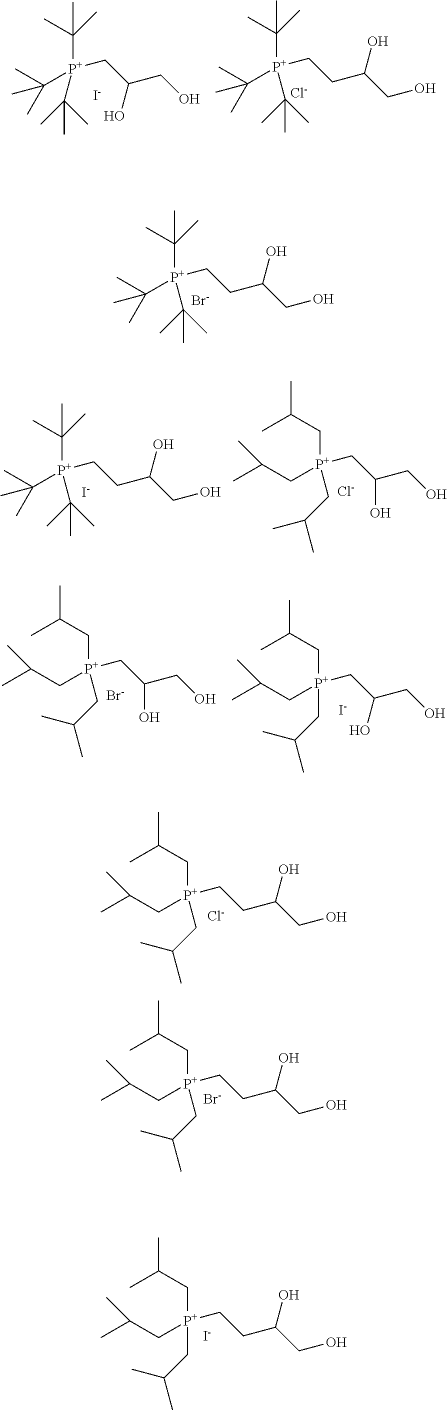

If preparing compounds for also including an aliphatic phosphonium salt as an end cap group, mono-alcohols can be prepared, in accordance with the following (Equation 2):

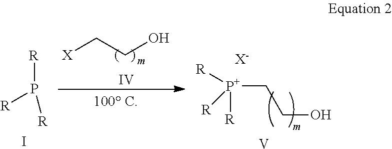

where R can independently be straight-chained or branched C1 to C5 or C2 to C5 alkyl; m can be from 1 to 18, from 1 to 14, from 1 to 10, from 2 to 18, from 2 to 10, from 1 to 5, or from 2 to 5; and X can be any suitable counterion for the positively charged phosphorus atom, such as bromide, chloride, or iodide, sulfonate, p-toluenesulfonate, trifluoromethanesulfonate, for example. Based on the general reaction scheme shown above as Equation 2, large numbers of example aliphatic phosphonium salt-based alcohols can be synthesized for inclusion as an end cap group on the polyurethane polymer. For example, when R is C1 to C5 alkyl, several example trialkylphosphonium salt-based alcohols can be formed, as shown below:

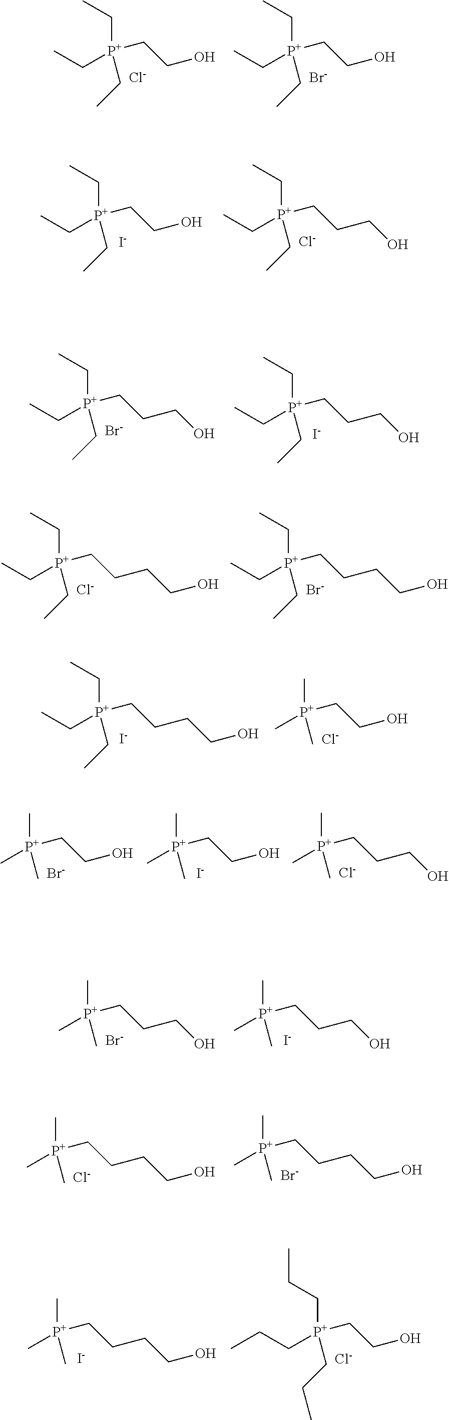

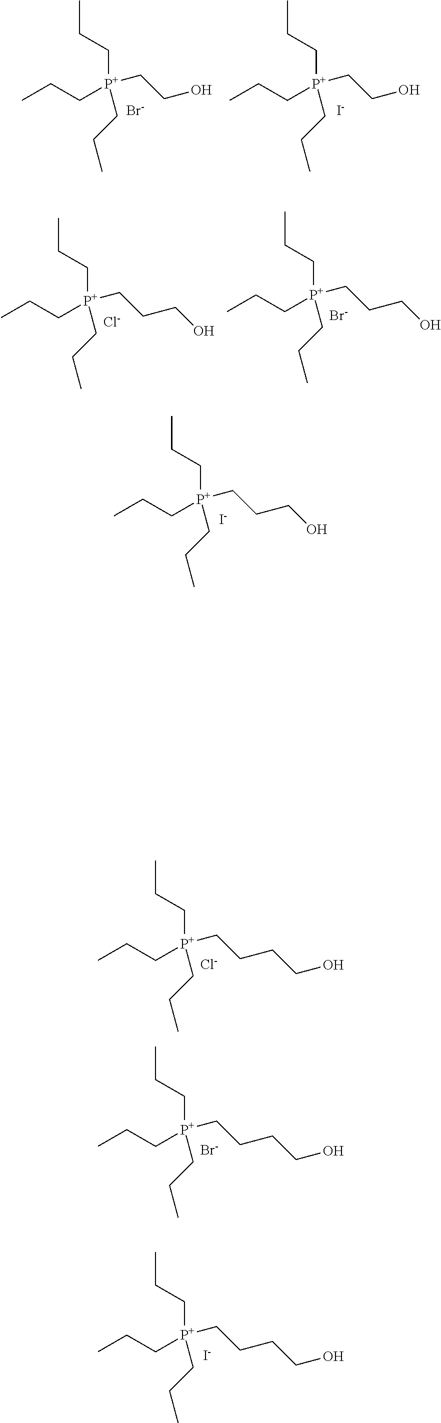

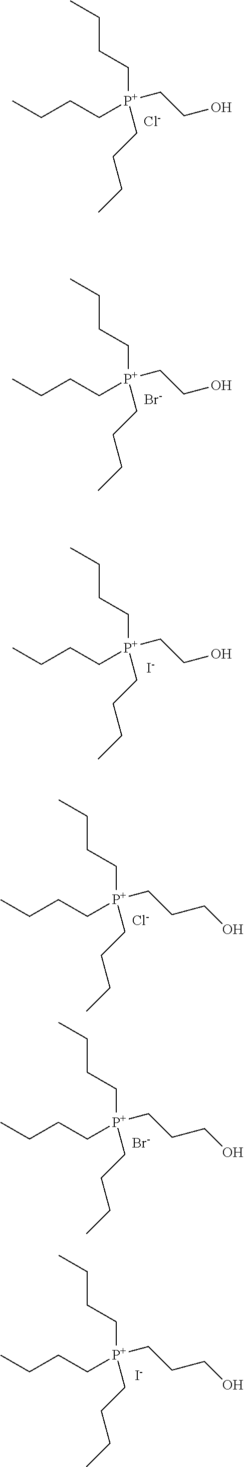

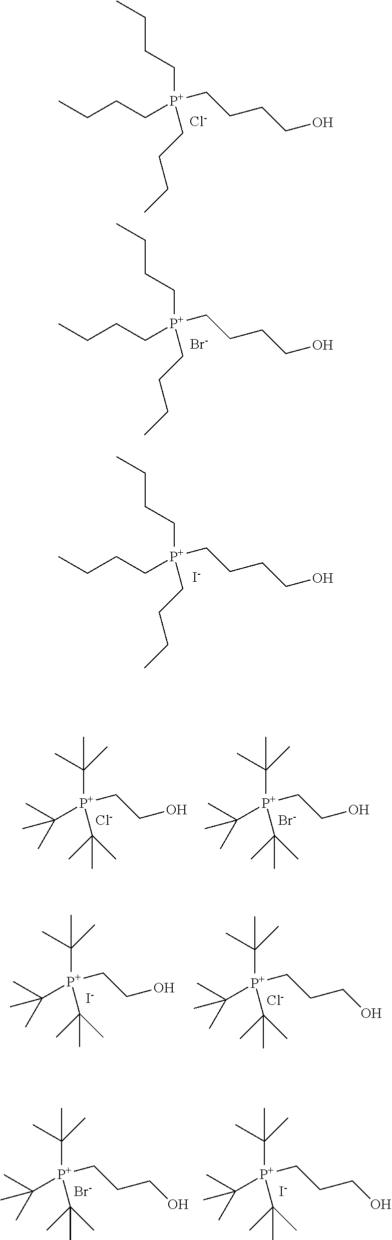

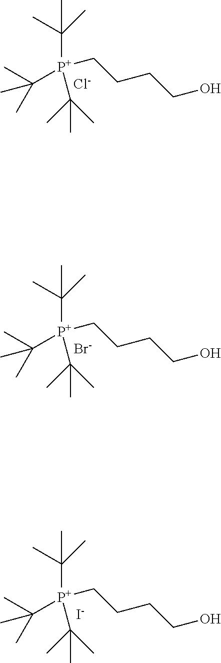 [SMILES: CC(C)(C)[P+](CCCCO)(C(C)(C)C)C(C)(C)C ; [Cl-] ; CC(C)(C)[P+](CCCCO)(C(C)(C)C)C(C)(C)C ; [Br-] ; CC(C)(C)[P+](CCCCO)(C(C)(C)C)C(C)(C)C ; [I-]]

In further detail, the epoxides can be included as pendant groups in the form of side chain groups or end cap groups. A few alcohol-based epoxides that can be used may include alcohol-based glycidyl ethers or amines. For example, two monoalcohol multiglycidyl ethers that can react with an isocyanate group to form end cap groups, including retaining the epoxide functional groups, are shown by example below:

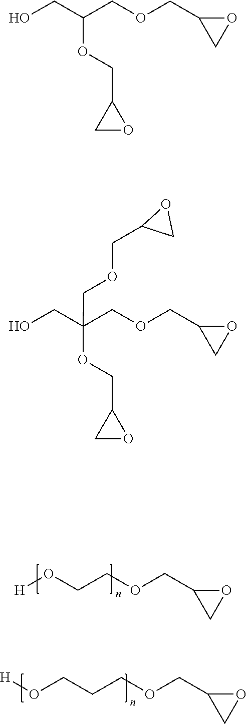

where n is from 1 to 100, or from 2 to 50, for example. With the above example epoxide-based alcohols above, two are multiglycidyl epoxides, e.g., a diglycidyl ether and a triglycidyl ether, having a hydroxyl group available for reaction with isocyanate groups that may be present along the polyurethane prepolymer that may be formed as an intermediate. The diglycidyl ether in the example shown above is a glycerol diglycidyl ether, and can be effective for use as an end cap group.

In other examples, there may be epoxide-containing diols that can be used to provide epoxide pendant groups as side chains along the polyurethane backbone, and a few examples are shown without limitation below:

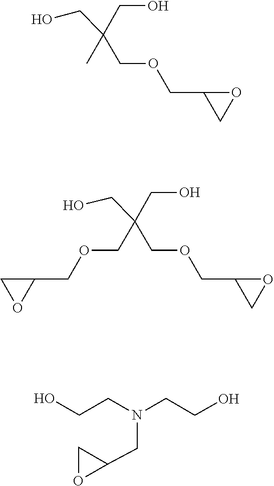 [SMILES: CC(CO)(CO)COCC1CO1 ; OCC(CO)(COCC1CO1)COCC1CO1 ; OCCN(CCO)CC1CO1]

With regard to the example alcohol-based epoxides above, one is a monoglycidyl ether, one is a diglycidyl ether, and another is a monoglycidyl amine. All three include multiple alcohol groups (polyols) that can be used to react to isocyanate groups to form part of a backbone of a polyurethane polymer (or prepolymer intermediate), for example.

In further detail, in some examples, the polyurethane polymers of the polyurethane particles can be prepared with polymeric portions from any of a number of other types of polymeric diols. Example polymeric diols that can be used include polyether diols (or polyalkylene diols), such as polyethylene oxide diols, polypropoylene oxide diols (or a hybrid diol of polyethylene oxide and polypropylene oxide), orpolytetrahydrofuran. Other polymeric diols that can be used include polyester diols, such as polyadipic ester diol, polyisophthalic acid ester diol, polyphthalic acid ester diol; or polycarbonate diols, such as hexanediol based polycarbonate diol, pentanediol based polycarbonate diol, hybrid hexanediol and pentanediol based polycarbonate diol, etc. Combinations of polymeric diols can also be used to prepare polyurethanes such as polycarbonate ester polyether-type polyurethanes, or other hybrid-types of polyurethane particles. In one specific example, however, the polyurethane particles prepared can be polyester polyurethanes. In forming the prepolymer, the reaction between the polymeric diols and the isocyanates can occur in the presence of a catalyst in acetone under reflux. The resultant prepolymer may include polymerized polymeric diols and polymerized isocyanates with urethane linkage groups along the polymer. In some specific examples, other reactants may also be used as mentioned (other types of diols, amines, etc.).

The following includes preparative examples that can be used to form polyurethane particles with pendant polyalkylene oxides, aliphatic phosphonium salts, and epoxides. These different types of pendant groups can be included as side chain groups or end cap groups, depending on their chemistry and/or time of inclusion into the reaction mixture. Thus, the following preparative reaction process is provided by example, and should not be considered limiting. More specifically, in certain examples, multi-functional polyurethane particles can be prepared by forming a prepolymer with polyalkylene oxide pendant side chain groups. The prepolymer can be formed more specifically by reacting a diisocyanate with a polyalkylene oxide diol in the presence of a catalyst in acetone under reflux to give the prepolymer (which includes isocyanate end groups with polyalkylene oxide side chains positioned along a polyurethane backbone). After the prepolymer is formed, an alkyl phosphonium salt with a hydroxyl group, such as a triphenylphosphonium-based alcohol, is reacted with the isocyanate end groups of the prepolymer to form end cap groups along a portion of the polyurethane polymers of the polyurethane particles. Additionally, after this reaction is complete, an epoxide-containing group with a hydroxyl group, such as glycerol diglycidyl ether, can be reacted with additional isocyanate groups that may still remain along a portion of the polyurethane polymers of the polyurethane particles to form epoxide pendant groups, which can be epoxide end cap groups when using a mono-alcohol epoxide or a side chain group when using a polyol epoxide, for example. In this example, more water can be added, and the organic solvent can be removed by vacuum distillation, for example, to provide a multi-functional polyurethane that can be stable in water, flame retardant as a media coating layer, and incudes a built-in epoxide crosslinker. Notably, the order can be modified. For example, in some examples the hydroxyl-containing epoxide can be introduced to the prepolymer first, followed by the hydroxyl-containing aliphatic phosphonium salt. In other examples, the prepolymer can be prepared using diols of the aliphatic phosphonium salt and/or diols of the epoxide to form side chains of these moieties along the polymer backbone. Alternatively, the polyalkylene oxide can be added to the prepolymer to introduce polyalkylene oxide end cap groups. That stated, in this specific example and others, the polyurethane particles can include polyurethane polymers with an acid number of 0. The D50 particle size in this example can be from 20 nm to 500 nm, for example, and in many cases from 20 nm to 200 nm.

In some examples, polyurethane prepolymer can be prepared with an NCO/OH ratio from about 1.2 to about 2.2. In another example, the polyurethane prepolymer can be prepared with an NCO/OH ratio from about 1.4 to about 2.0. In yet another example, the polyurethane prepolymer can be prepared using an NCO/OH ratio from about 1.6 to about 1.8. In further detail, the weight average molecular weight of the polyurethane prepolymer can range from 5,000 Mw to 500,000 Mw, 5,000 Mw to 400,000 Mw, or from 10,000 Mw to 300,000 Mw, as measured by gel permeation chromatography. In another example, the weight average molecular weight of the polyurethane prepolymer can range from 40,000 Mw to 180,000 Mw, or from 60,000 Mw to 140,000 Mw, also as measured by gel permeation chromatography, for example.

In addition to the polyurethane particles with polyalkylene oxides, aliphatic phosphonium salts, and epoxide pendant groups, in some examples, the multi-functional polyurethane coating compositions can include other components, as mentioned. In one example, the other component can be second polymer resins and/or other small molecular organic compounds, such as other crosslinkers (in addition to the pendant epoxides described herein). The second polymer resins can be, for example, polyacrylate, polyurethane, vinyl-urethane, acrylic urethane, polyurethane-acrylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, derivatives thereof, or combinations thereof. These other components can be formulated and/or selected so that they do not react with the epoxide groups of the polyurethane particles around ambient temperatures and temperatures slightly below and above ambient, e.g., from 0° C. to 50° C., but when heat is added after application to an ink composition to an ink-receiving layer including the multi-functional polyurethane particles, the components may react with the epoxide groups that are appended to the polyurethane backbone.

In one example, the second polymer resin can be a polyacrylate. Example polyacrylate based polymers can include polymers made by hydrophobic addition monomers including, but are not limited to, C1-C12 alkyl acrylate and methacrylate (e.g., methyl acrylate, ethyl acrylate, n-propyl acrylate, isopropyl acrylate, n-butyl acrylate, isobutyl acrylate, sec-butyl acrylate, tert-butyl acrylate, 2-ethylhexyl acrylate, octyl arylate, methyl methacrylate, ethyl methacrylate, n-propyl methacrylate, isopropyl methacrylate, n-butyl methacrylate, isobutyl methacrylate, sec-butyl methacrylate, tert-butyl methacrylate), and aromatic monomers (e.g., styrene, phenyl methacrylate, o-tolyl methacrylate, m-tolyl methacrylate, p-tolyl methacrylate, benzyl methacrylate), hydroxyl containing monomers (e.g., hydroxyethylacrylate, hydroxyethylmthacrylate), carboxylic containing monomers (e.g., acrylic acid, methacrylic acid), vinyl ester monomers (e.g., vinyl acetate, vinyl propionate, vinylbenzoate, vinylpivalate, vinyl-2-ethylhexanoate, vinylversatate), vinyl benzene monomer, C1-C12 alkyl acrylamide and methacrylamide (e.g., t-butyl acrylamide, sec-butyl acrylamide, N,N-dimethylacrylamide), crosslinking monomers (e.g., divinyl benzene, ethyleneglycoldimethacrylate, bis(acryloylamido)methylene), or combinations thereof. Polymers made from the polymerization and/or copolymerization of alkyl acrylate, alkyl methacrylate, vinyl esters, and styrene derivatives may also be useful. In one example, the polyacrylate based polymer can include polymers having a glass transition temperature of greater than 20° C. In another example, the polyacrylate based polymer can include polymers having a glass transition temperature of greater than 40° C. In yet another example, the polyacrylate based polymer can include polymers having a glass transition temperature of greater than 50° C.

In one example, the second polymer resin can include a (different) polyurethane polymer. The polyurethane polymer can be hydrophilic. The polyurethane can be formed in one example by reacting an isocyanate with a polyol. Example isocyanates used to form the polyurethane polymer can include toluenediisocyanate, 1,6-hexamethylenediisocyanate, diphenylmethanediisocyanate, 1,3-bis(isocyanatemethyl)cyclohexane, 1,4-cyclohexyldiisocyanate, p-phenylenediisocyanate, 2,2,4(2,4,4)-trimethylhexamethylenediisocyanate, 4,4′-dicychlohexylmethanediisocyanate, 3,3′-dimethyldiphenyl, 4,4′-diisocyanate, m-xylenediisocyanate, tetramethylxylenediisocyanate, 1,5-naphthalenediisocyanate, dimethyltriphenylmethanetetraisocyanate, triphenylmethanetriisocyanate, tris(isocyanatephenyl)thiophosphate, or combinations thereof. Commerically available isocyanates can include RhodocoatTM WT 2102 (available from Rhodia AG, Germany), Basonat® LR 8878 (available from BASF Corporation, N. America), Desmodur® DA, and Bayhydur® 3100 (Desmodur and Bayhydur available from Bayer AG, Germany). In some examples, the isocyanate can be protected from water. Example polyols can include 1,4-butanediol; 1,3-propanediol; 1,2-ethanediol; 1,2-propanediol; 1,6-hexanediol; 2-methyl-1,3-propanediol; 2,2-dimethyl-1,3-propanediol; neopentyl glycol; cyclohexanedimethanol; 1,2,3-propanetriol; 2-ethyl-2-hydroxymethyl-1,3-propanediol; or combinations thereof. In some examples, the isocyanate and the polyol can have less than three functional end groups per molecule. In another example, the isocyanate and the polyol can have less than five functional end groups per molecule. In yet another example, the polyurethane can be formed from a polyisocyanate having at least two isocyanate functionalities and a polyol having at least two hydroxyl or amine groups. Example polyisocyanates can include diisocyanate monomers and oligomers.

Example secondary polyurethane polymers can include polyester based polyurethanes, U910, U938 U2101 and U420; polyether-based polyurethane, U205, U410, U500 and U400N; polycarbonate-based polyurethanes, U930, U933, U915 and U911; castor oil-based polyurethane, CUR21, CUR69, CUR99 and CUR991; or combinations thereof. (All of these polyurethanes are available from Alberdingk Boley Inc., North Carolina).

In some examples the polyurethane can be aliphatic or aromatic. In one example, the polyurethane can include an aromatic polyether polyurethane, an aliphatic polyether polyurethane, an aromatic polyester polyurethane, an aliphatic polyester polyurethane, an aromatic polycaprolactam polyurethane, an aliphatic polycaprolactam polyurethane, or a combination thereof. In another example, the polyurethane can include an aromatic polyether polyurethane, an aliphatic polyether polyurethane, an aromatic polyester polyurethane, an aliphatic polyester polyurethane, or a combination thereof. Example commercially-available polyurethanes can include; NeoPac® R-9000, R-9699, and R-9030 (available from Zeneca Resins, Ohio), Printrite™ DP376 and Sancure® AU4010 (available from Lubrizol Advanced Materials, Inc., Ohio), and Hybridur® 570 (available from Air Products and Chemicals Inc., Pennsylvania), Sancure® 2710, Avalure® UR445 (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure® 878, Sancure® 815, Sancure® 1301, Sancure® 2715, Sancure® 2026, Sancure® 1818, Sancure® 853, Sancure® 830, Sancure® 825, Sancure® 776, Sancure® 850, Sancure® 12140, Sancure® 12619, Sancure® 835, Sancure® 843, Sancure® 898, Sancure® 899, Sancure® 1511, Sancure® 1514, Sancure® 1517, Sancure® 1591, Sancure® 2255, Sancure® 2260, Sancure® 2310, Sancure® 2725, Sancure® 12471, (all commercially available from Lubrizol Advanced Materials, Inc., Ohio), or combinations thereof.

In some examples, the polyurethane can be crosslinked using a crosslinking agent. In one example, the crosslinking agent can be a blocked polyisocyanate. In another example, the blocked polyisocyanate can be blocked using polyalkylene oxide units. In some examples, the blocking units on the blocked polyisocyanate can be removed by heating the blocked polyisocyanate to a temperature at or above the deblocking temperature of the blocked polyisocyanate in order to yield free isocyanate groups. An example blocked polyisocyanate can include Bayhydur® VP LS 2306 (available from Bayer AG, Germany). In another example, the crosslinking can occur at trimethyloxysilane groups along the polyurethane chain. Hydrolysis can cause the trimethyloxysilane groups to crosslink and form a silesquioxane structure. In another example, the crosslinking can occur at acrylic functional groups along the polyurethane chain. Nucleophilic addition to an acrylate group by an acetoacetoxy functional group can allow for crosslinking on polyurethanes including acrylic functional groups. In other examples the polyurethane polymer can be a self-crosslinked polyurethane. Self-crosslinked polyurethanes can be formed, in one example, by reacting an isocyanate with a polyol.

In another example, the second polymer resin can include an epoxy. The epoxy can be an alkyl epoxy resin, an alkyl aromatic epoxy resin, an aromatic epoxy resin, epoxy novolac resins, epoxy resin derivatives, or combinations thereof. In some examples, the epoxy can include an epoxy functional resin having one, two, three, or more pendant epoxy moieties.

In one example, the epoxy resin can be self-crosslinked. Self-crosslinked epoxy resins can include polyglycidyl resins, polyoxirane resins, or combinations thereof. Polyglycidyl and polyoxirane resins can be self-crosslinked by a catalytic homopolymerization reaction of the oxirane functional group or by reacting with co-reactants such as polyfunctional amines, acids, acid anhydrides, phenols, alcohols, and/or thiols.

In other examples, the epoxy resin can be crosslinked by an epoxy resin hardener. Epoxy resin hardeners can be included in solid form, in a water emulsion, and/or in a solvent emulsion. The epoxy resin hardener, in one example, can include liquid aliphatic amine hardeners, cycloaliphatic amine hardeners, amine adducts, amine adducts with alcohols, amine adducts with phenols, amine adducts with alcohols and phenols, amine adducts with emulsifiers, ammine adducts with alcohols and emulsifiers, polyamines, polyfunctional polyamines, acids, acid anhydrides, phenols, alcohols, thiols, or combinations thereof.

In addition to the water and the polyurethane particles, and in some instances the second polymer resin and/or crosslinkers, the multi-functional polyurethane print media coating composition and ink-receiving layer on the multi-functional polyurethane coated print media can include other solids. Examples can include inorganic pigment(s), such as white inorganic pigments if the media is intended to be white, for example. Examples of inorganic pigments that may be used include, but are not limited to, aluminum silicate, kaolin clay, a calcium carbonate, silica, alumina, boehmite, mica and talc, or combinations or mixtures thereof. In some examples, the inorganic pigment includes a clay or a clay mixture. In some examples, the inorganic pigment includes a calcium carbonate or a calcium carbonate mixture. The calcium carbonate may be one or more of ground calcium carbonate (GCC), precipitated calcium carbonate (PCC), modified GCC, and modified PCC, for example. For example, the inorganic pigment may include a mixture of a calcium carbonate and a clay. The particulate fillers can have average particle size ranging from 0.1 μm to 20 μm, with a dry weight ratio of polyurethane particles to particulate filler ranging from 100:1 to 1:20, from 50:1 to 10:1, from 20:1 to 5:1, or from 10:1 to 1:1, for example. A specific example of a particulate filler that can be used is NuCap®, which is available from Kamin, LLC, USA.

In some examples, there are other additives that can be used or included, such as coating composition thickener, such as Tylose® HS-100K, available from SE Tylose GmbH & Co. KG, Germany. Surfactant, such as Pluronic® L61, available from BASF SE, Germany, can also be included. Other commercially-available surfactants that can be used include the TAMOLTM series from Dow Chemical Co., nonyl and octyl phenol ethoxylates from Dow Chemical Co. (e.g., Triton™ X-45, Triton™ X-100, Triton™ X-114, Triton™ X-165, Triton ™ X-305 and Triton™ X-405) and other suppliers (e.g., the T-DETTM N series from Harcros Chemicals), alkyl phenol ethoxylate (APE) replacements from Dow Chemical Co., Elementis Specialties, and others, various members of the Surfynol® series from Air Products and Chemicals, (e.g., Surfynol® 104, Surfynol® 104A, Surfynol® 104BC, Surfynol® 104DPM, Surfynol® 104E, Surfynol® 104H, Surfynol® 104PA, Surfynol® 104PG50, Surfynol® 104S, Surfynol® 2502, Surfynol® 420, Surfynol® 440, Surfynol® 465, Surfynol® 485, Surfynol® 485W, Surfynol® 82, Surfynol® CT-211, Surfynol® CT-221, Surfynol® OP-340, Surfynol® PSA204, Surfynol® PSA216, Surfynol® PSA336, Surfynol® SE and Surfynol® SE-F), Capstone® FS-35 from DuPont, various fluorocarbon surfactants from 3M, E.I. DuPont, and other suppliers, and phosphate esters from Ashland, Rhodia and other suppliers. Dynwet® 800, for example, from BYK-chemie, Gmbh (Germany), can also be used.

When applying the multi-functional polyurethane print media coating composition to a print media substrate, the coating composition can be applied to any print media substrate type using any method appropriate for the coating application properties, e.g., thickness, viscosity, etc. Non-limiting examples of methods include dipping coating, padding, slot die, blade coating, and Meyer rod coating. When the coating composition is dried by removal of water and/or other volatile solvent content, the coating composition can form an ink-receiving layer. Drying can be carried out by air drying, heated airflow drying, baking, infrared heated drying, etc. Other processing methods and equipment can also be used. For one example, the multi-functional polyurethane print media substrate can be passed between a pair of rollers, as part of a calendering process, after drying. The calendering device can be any kind of calendaring apparatus, including but not limited to off-line super-calender, on-line calender, soft-nip calender, hard-nip calender, or the like.

In further detail and by way of example, a textile or paper substrate can be modified on single or both sides with the ink-receiving layer. In one example, the ink-receiving layer can be formed on a print media substrate with a dried coating weight from 0.3 grams/m² (gsm) to 30 gsm, from 0.5 gsm to 20 gsm, from 0.8 gsm to 20 gsm, from 0.5 gsm to 10 gsm, from 0.8 gsm to 10 gsm, from 0.8 gsm to 5 gsm, from 0.8 gsm to 3 gsm, from 1 gsm to 15 gsm, from 1 gsm to 1 gsm, or from 1 gsm to 5 gsm. The coatings of the present disclosure can be applied with varying degrees of smoothness, as well as to provide the ability of the coated media to absorb ink or to evenly distribute ink colorant, e.g., pigment. Furthermore, the multi-functional polyurethane coating composition, when applied to a print media substrate, can in many cases act favorably with respect to increased media opacity, brightness, whiteness, glossiness, and/or surface smoothness of the image-receiving layer in some examples.

The multi-functional polyurethane print media coating compositions, multi-functional polyurethane coated print media, and methods of coating print media described herein can be suitable for use with many types of print media, including paper, fabric, plastic, e.g., plastic film, metal, e.g., metallic foil, and other types of printable substrates, including combinations and/or composites thereof. In particular, textiles or fabrics can be treated with the multi-functional polyurethane print media coating compositions of the present disclosure, including cotton fibers, treated and untreated cotton substrates, polyester substrates, nylons, blended substrates thereof, etc. It is notable that the term “fabric substrate” or “fabric print media substrate” does not include print media substrate materials such as any paper (even though paper can include multiple types of natural and synthetic fibers or mixtures of both types of fibers). Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as nylon fibers (also referred to as polyamide fibers), polyvinyl chloride (PVC) fibers, PVC-free fibers made of polyester, polyamide, polyimide, polyacrylic, polypropylene, polyethylene, polyurethane, polystyrene, polyaramid, e.g., Kevlar® (E. I. du Pont de Nemours Company, USA), polytetrafluoroethylene, fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both of the polymeric fiber and a surface of the fabric, a plasma treatment, a solvent treatment, acid etching, or a biological treatment, an enzyme treatment, or antimicrobial treatment to prevent biological degradation.

Thus, the fabric substrate can include natural fiber and synthetic fiber, e.g., cotton/polyester blend. The amount of each fiber type can vary. For example, the amount of the natural fiber can vary from about 5 wt % to about 95 wt % and the amount of the synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of the synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa. The fabric substrate can be in one of many different forms, including, for example, a textile, a cloth, a fabric material, fabric clothing, or other fabric product suitable for applying ink, and the fabric substrate can have any of a number of fabric structures, including structures that can have warp and weft, and/or can be woven, non-woven, knitted, tufted, crocheted, knotted, and pressured, for example. The terms “warp” as used herein, refers to lengthwise or longitudinal yarns on a loom, while “weft” refers to crosswise or transverse yarns on a loom.

The basis weight of the print media, such as the paper, fabric, plastic film, foil, etc., can be from 20 gsm to 500 gsm, from 40 gsm to 400 gsm, from 50 gsm to 250 gsm, or from 75 gsm to 150 gsm, for example. Some print media substrates can be toward the thinner end of the spectrum, and other print media substrates may be thicker, and thus, the weight basis ranges given are provided by example, and are not intended to be limiting.

Regardless of the print media substrate used, such substrates can contain or be coated with additives including, but not limited to, colorant (e.g., pigments, dyes, and tints), antistatic agents, brightening agents, nucleating agents, antioxidants, UV stabilizers, and/or fillers and lubricants, for example. Alternatively, the print media substrates may be pre-treated in a solution containing the substances listed above before applying other treatments or coating layers.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all zo the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1

### Synthesis of Aliphatic Phosphonium Salt-based Diol (for Polyurethane Backbone)

Hydroxylpropyltributylphosphonium chloride salt (TBPDHPCI) was prepared in accordance with Formula 1, and as further described below:

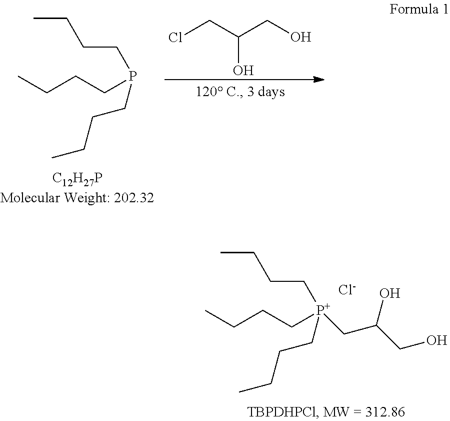 [SMILES: CCCCP(CCCC)CCCC ; OCC(O)CCl ; CCCC[P+](CCCC)(CCCC)CC(O)CO ; [Cl-]]

In accordance with Formula 1, a 500 mL four-necked flask equipped with a mechanical stirrer, a thermometer, a dropping funnel, and a condenser was purged with nitrogen, and 150 g (0.741 mol) of tri-n-butylphosphine was added. At 80° C., 86.11 g (0.779 mol) of 1-chloro-2,3-propanediol was added dropwise over 30 minutes, and the solution zo turned white and cloudy. The solution continued to be heated to 120° C. for 2 days under nitrogen and stirring. The reaction solution was a viscous, colorless, and transparent liquid. The presence of unreacted trialkylphosphine was tested using carbon disulphide, but trialkylphosphine was not detected. The solution was concentrated using an evaporator and then dried with a vacuum pump to give 226.03 g of a colorless and transparent viscous liquid. The titration purity was 100.0% and the yield was 97.5 wt %

### Example 2

### Synthesis of Aliphatic Phosphonium Salt-based Mono-Alcohol (for Polyurethane End Cap Groups)

Hydroxylpropyltributylphosphonium chloride salt (TBPHECI) was prepared as per Formula 2 and as further described below:

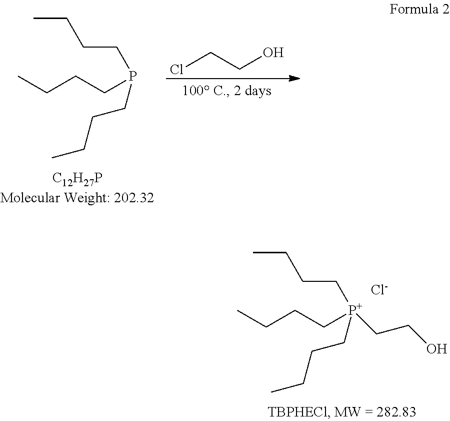

In accordance with Formula 2, a 500 mL four-necked flask equipped with a mechanical stirrer, a thermometer, a dropping funnel, and a condenser was purged with nitrogen and 150 g (0.741 mol) of tri-n-butylphosphine was added. At 80° C., 62.7 g (0.779 mol) of 2-chloroethanol was added dropwise over 30 minutes and the solution turned white and cloudy. The solution continued to be heated to 100° C. for 2 days under nitrogen and stirring. The reaction solution was very viscous but was colorless and transparent. The presence of unreacted trialkylphosphine was tested using carbon disulphide, but trlalkylphosphine was not detected. The solution was concentrated using an evaporator and then dried with a vacuum pump to give 206.4 g of a colorless and transparent viscous liquid. The titration purity was 100.0% and the yield was 98.5 wt %.

### Example 3

### Preparation of Multi-Functional Polyurethane Dispersion 1 (D1)

25.211 g of g of Ymer N-120 (polyol with polyethylene oxide side group, molecular weight 1000), 25.472 g of isophorone diisocyanate (IPDI), and 64 g of acetone were mixed in a 500 ml of 4-neck round bottom flask. A mechanical stirrer with glass rod and Teflon® blade was attached, as was a condenser. The flask was immersed in a constant temperature bath at 75° C. The system was kept under drying tube. Next, 3 drops of bismuth catalyst (Reaxis C3203) was added to initiate polymerization. Polymerization was continued for 3 hours at 75° C. 0.5g of pre-polymer which included isocyanate excess isocyanate groups and a polyethylene oxide side was withdrawn for final %wt NCO titration. The measured NCO value was 14.79 wt %. The theoretical % NCO should have been 14.81 wt %, so it was very close. Next, 46.347 g of hydroxyethyltributylphosphonium chloride (TBPHECI) from Example 2 in 20 ml of acetone was added to the prepolymer over a 10 minute period of time. Polymerization was continued for 3 hours at 75° C. 0.5 g of prepolymer reaction product was withdrawn for final % NCO titration. The measured NCO value was 0.60 wt %, indicating that there were still some free NCO groups available for reaction. The theoretical % NCO should be 0.64%, which again was very close to the measured value. The temperature was then reduced to 50° C., and then 2.97 g of glycerol diglycidyl ether in 10 ml of acetone was added over 10 minutes, which included the epoxide groups. Polymerization was continued for 60 additional minutes, and then 258.818 of DI water was added over another 20 minutes. The solution became milky and white in color and the milky dispersion continued to stir overnight at room temperature. The PUD dispersion was filtered through a 400 mesh stainless sieve. The acetone was removed with a Rotorvap at 50° C., and 2 drops (20mg) BYK-011 de-foaming agent was also added. The final PUD dispersion was filtered through fiber glass filter paper. Particle size was measured by Malvern Zetasizer at a D50 of about 0.8 nm. The pH of the multi-functional polyurethane particle dispersion was 8.5, and the solids content was 29.34 wt %. In this example, the polyurethane particles included polyalkylene oxide side chains, aliphatic phosphonium salt end cap groups, and epoxide end cap groups.

### Example 4

### Preparation of Multi-Functional Polyurethane Dispersion 2 (D2)

25.502 g of g of Ymer N-120 (polyol with polyethylene oxide side group, molecular weight 1000), 25.766 g of isophorone diisocyanate (IPDI), and 64 g of acetone were mixed in a 500 ml of 4-neck round bottom flask. A mechanical stirrer with glass rod and Teflon blade was attached. A condenser was attached. The flask was immersed in a constant temperature bath at 75° C. and kept under a drying tube. 3 drops of bismuth catalyst (Reaxis C3203) was added to initiate the polymerization. Polymerization was continued for 3 hours at 75° C. 0.5g of pre-polymer was withdrawn for final wt % NCO titration. The measured NCO value was 14.75 wt %, which was very close to the theoretical wt % NCO of 14.81 wt %. 42.722 g of hydroxyethyltributyl-phosphonium chloride (TBPHECI) from Example 2 in 20 ml of acetone was added over 10 minutes. Polymerization was continued for 3 hours at 75° C. 0.5g of reacted prepolymer (now including the aliphatic phosphonium salt) was withdrawn for final wt % NCO titration. The measured NCO value was 1.30 wt %, which was close to the theoretical wt % NCO value of 1.33 wt %. The temperature was reduced to 50° C., and 6.009 g of glycerol diglycidyl ether in 15 ml of acetone was added over 10 minutes (which included the epoxide groups). Polymerization was continued for 60 additional minutes, and then 258.231 of DI water was added over the next 20 minutes. The solution became milky and white in color and the milky dispersion continued to stir overnight at room temperature. The multi-functional polyurethane particle dispersion was filtered through a 400 mesh stainless sieve, the acetone was removed with a Rotorvap at 50° C., and 2 drops (20 mg) BYK-011 de-foaming agent was added. The final multi-functional polyurethane particle dispersion was filtered again, this time through fiber glass filter paper. The D50 particle size was measured by Malvern Zetasizer is at about 7.6 nm. The pH of the dispersion was 8.5, and the multi-functional polyurethane particle content in the dispersion was 29 wt %. In this example, the polyurethane particles included polyalkylene oxide side chains, aliphatic phosphonium salt end cap groups, and epoxide end cap groups.

### Example 5

### Alternative Preparations of Multi-Functional Polyurethane Particle Dispersions

Various alternative polyurethane particles can be prepared similar to that described in accordance with Examples 3 and 4, depending on the order of addition of the various pendent groups, whether or not the pendent groups are added as diols or as mono-alcohols, etc. For example, the aliphatic phosphonium salt-based diol prepared in accordance with Example 1 may be used to form a prepolymer with an aliphatic phosphonium side chain, and the end cap groups can be provided by the glycerol diglycidyl ether.

### Example 6

### Preparation of Multi-Functional Polyurethane Coating Compositions

Two multi-functional polyurethane coating compositions were prepared, namely Coating 1 and Coating 2, in accordance with Table 1, as follows:

TABLE 1
Coating Formulations

| | | Coating 1 | Coating 2 |
|---|---|---|---|
| | | (wt % | (wt % |
| Ingredients | Active Component | solids) | solids) |
| D1 | Multi-functional | 1 | — |
| | Polyurethane Particles | | |
| D2 | Multi-functional | — | 1 |
| | Polyurethane Particles | | |
| Anquawhite ® 100, from | Polyamine Reactive | 0.99 wt % | 0.99 wt % |
| Air Products, Inc. (USA) | Polymer | (solids) | (solids) |
| Dynwet ® 800, from | Surfactant | 0.01 wt % | 0.01 wt % |
| BYK-Inc. (Germany) | | | |
| DI Water | Solvent Liquid Vehicle | 98.00% | 98.00% |

### Example 7

### Preparation of Coated Print Media with Multi-Functional Polyurethane Particle-containing Coatings, Image Quality, and Print Durability

Coating 1 and Coating 2 from Example 6 were independently applied at a coating weight basis of about 3 gsm onto a polyester fabric substrate having a plain weave and a substrate weight basis of about 130 gsm. The coating composition was applied using a lab Methis padder with the speed of 5 meters per minute. The epoxide groups of Coatings 1 and 2 were stable at room temperature. Then, the coated fabric was dried using an IR oven at a peak temperature of 120° C. At this temperature, the epoxide groups can become opened and available from crosslinking, example.

Print Media prepared in accordance with the present disclosure is labeled below in Table 1 as including Coating 1 or Coating 2. A Comparative Print Medium was also evaluated for flame resistance and is labeled as Comparative 1. Comparative 1 is an uncoated fabric substrate of the same type.

The coated fabric substrates were printed with a pigmented ink composition using an HP® L 360 printer available from HP, Inc. (USA). The multi-functional polyurethane coated and subsequently printed fabric substrates were evaluated for resistance to scratch, dry rub, wrinkle, and flame resistance using a testing protocol referred to the NFPA 701 FR Test. The printed images were also evaluated for dark line, gamut, optical density (OD), and L*min.

The testing protocols for the data collected below as shown in Table 2 was as follows:
Scratch testing was carried out using a coin to scratch the ink printed on the ink-receiving layer of the fabric substrates. Scratch testing was carried out on the printed fabrics using all available colors (cyan, magenta, yellow, and any others available). The samples were subjected to a scratch testing by a coin-like test header which was 45 degrees facing the surface of the tested samples. Scratching under a normal force of 800 g was used. The test was done in a BYK Abrasion Tester (from BYK-Gardner, USA) with a linear, back-and-forth action, attempting to scratch off the image side of the samples (5 cycles). The image durability was evaluated visually. Scores ranging from 1 to 4 were used, as indicated at the bottom of Table 2.
Dry Rub resistance was tested by using an abrasion scrub tester. For this test, the fabrics were printed with available colors, e.g., cyan, magenta, yellow, and/or others). A weight of 250 g was loaded on a test header. The test tip made of acrylic resin with crock cloth was used. The device was set to move the tip at 25 cm/min for a total of 8 inches, cycled 5 times. The test probe was evaluated in dry (dry rub) mode. The ink transferred to the test cloth was evaluated visually. Scores ranging from 1 to 4 were used, with 4 indicating the best performance, 1 indicating the worst performance, and a score of 3 was considered passing.
Wrinkle Resistance was evaluated manually by multiple operators (n=5) by crinkling and holding the textile in hands for 1 minute and then placing the fabric samples flatly on a surface and evaluating the degree of wrinkle. Scores ranging from 1 to 4 were used, with 4 indicating the best performance (insignificant wrinkling), 1 indicating the worst performance, and a score of 3 was considered passing.
Flame retardance or resistance is evaluated based on NFPA 701 standard (Standard Methods of Fire Tests for Flame Propagation of Textiles and Films). This methodology measures ignition resistance of a fabric after it is exposed to a flame for 12 seconds, and then the flame, char length, and flaming residue are recorded, with “passing” criteria based on a total weight loss less than 40 w % after burning, and a burning time of residual drops at less than 2 seconds. “Residual drops” refer to the melted burning drops from the fabric substrate that occur during the burning test when the samples are handled vertically.
Gamut was measured using a Macbeth TD904 (Macbeth Process Measurement) machine.
Optical Density (OD) and L*min were measured in this example using a X Rite 938 Spectro Densitometer.
Dark Line testing was carried out for visual inspection under lighting. The sample is prepared by folding printed fabric three turnings and placing a 5 pound weight on top of the folded fabric for 10 minutes.

TABLE 2
Image Quality and Durability on Fabric Substrates with and Without
Ink-receiving Coatings with Multi-functional Polyurethane Particles

| | Scratch | Dry | | NFPA 701 | | | L* | Dark |
|---|---|---|---|---|---|---|---|---|
| Coating ID | Test | Rub | Wrinkle | FR Test | Gamut | OD | Min | Line |
| Coating 1 | 3 | 4 | 4 | 3 | 291K | 1.3 | 26 | 3 |
| Coating 2 | 3 | 4 | 4 | 3 | 292K | 1.3 | 26 | 4 |
| Comparative 1 | 4 | 3 | 2 | 2 | 207K | 1.2 | 27 | 1 |

For Visual Scoring: 1 = Fail; 2 = Marginal; 3 = Pass; 4 = Excellent

As can be seen by the data collected in Table 2, the inclusion of the aliphatic phosphonium salt, e.g., cationic trialkylphosphonium salt, can provide enhanced flame-resistance to polyurethane particles on the fabric substrates. Furthermore, the dry rub durability in particular can be enhanced by the crosslinking that can occur due to the epoxide groups included on the multi-functional polyurethane polymers of the polyurethane particles. It is noted that the scratch resistance was slightly better with uncoated fabric, however, the scratch resistance was still considered passing, but the image quality was quite a bit better with the coated fabric, as evidenced particularly by the gamut values and the dark line scores. Furthermore, this combination of pendant groups also provided passing or excellent gamut, L*min, and dark line values. Thus, the multi-functional polyurethanes of the present disclosure can provide properties that cause the polyurethane particles to have multiple functions, such as exhibiting binder properties as well as crosslinking to enhance durability, flame-resistance to contribute to safety concerns, fixing properties (due to the cationic phosphonium group) to contribute to image quality enhancement, etc.

What is claimed is:

1. A multi-functional polyurethane coating composition, comprising:
water; and
polyurethane particles including a blend of polyurethane polymers with polyurethane backbones, wherein the polyurethane particles include multiple pendant groups independently attached to one or multiple polyurethane backbones within the blend of polyurethane polymers, wherein the multiple pendant groups of the polyurethane particles include polyalkylene oxides, aliphatic phosphonium salts, and epoxides.

2. The multi-functional polyurethane coating composition of claim 1, wherein the epoxide appended to the polyurethane backbone is from an alcohol-based glycidyl ether or amine.

3. The multi-functional polyurethane coating composition of claim 1, wherein the epoxide is included on one or multiple polyurethane backbones as an end cap group.

4. The multi-functional polyurethane coating composition of claim 1, wherein the aliphatic phosphonium salt is included on one or multiple polyurethane backbones as an end cap group.

5. The multi-functional polyurethane coating composition of claim 1, wherein the aliphatic phosphonium salt is included on one or multiple polyurethane backbones as a side chain group.

6. The multi-functional polyurethane coating composition of claim 1, wherein the polyalkylene oxide is included on one or multiple polyurethane backbones as a side chain group.

7. The multi-functional polyurethane coating composition of claim 1, wherein the polyalkylene oxide is a polyethylene oxide, a polypropylene oxide, or a combination of polyethylene oxide and polypropylene oxide.

8. The multi-functional polyurethane coating composition of claim 1, wherein one or multiple polyurethane backbones of the polyurethane blend include polymeric portions that bridge urethane linkage groups, wherein the polymeric portions are formed from copolymerized polymeric polyols including: polyether polymer polyols, polyester polymer polyols, polycarbonate polymer polyols, or a combination thereof.

9. The multi-functional polyurethane coating composition of claim 1, wherein the urethane linkage groups are formed by reacting polymeric polyols with 2,2,4-trimethylhexane-1,6-diisocyanate; 2,4,4-trimethylhexane-1,6-diisocyanate;
hexamethylene diisocyanate; methylene diphenyl diisocyanate; isophorone diisocyanate; 1-Isocyanato-4-[(4-isocyanatocyclohexyl)methyl]cyclohexan; or a combination thereof.

10. A coated print medium, comprising:
a print media substrate; and
an ink-receiving layer on the print media substrate, the ink-receiving layer comprising polyurethane particles including a blend of polyurethane polymers with polyurethane backbones, wherein the polyurethane particles includes multiple pendant groups independently attached to one or multiple polyurethane backbones within the blend of polyurethane polymers, wherein the multiple pendant groups of the polyurethane particles include polyalkylene oxides, aliphatic phosphonium salts, and epoxides.

11. The coated print medium of claim 10, wherein:
the epoxide group is included on one or multiple polyurethane backbones as an end cap group,
the aliphatic phosphonium salt is included on one or multiple polyurethane backbones as an end cap group, as a side chain group, or both an end cap group and a side chain group, and
polyalkylene oxide is included on one or multiple polyurethane backbones as a side chain group.

12. The coated print medium of claim 10, wherein the ink-receiving layer further comprising a second polymer with a functional group reactive the epoxide to open the epoxide upon application of heat from 80° C. to 200° C., but which is stable in the presence of the epoxide at temperatures from 0° C. to 50° C.

13. The coated print medium of claim 10, wherein the print media substrate is a fabric substrate.

14. A method of making a coated print medium, comprising:
applying a multi-functional polyurethane coating composition as a layer to a print media substrate, the multi-functional polyurethane coating composition including:
water, and
polyurethane particles including a blend of polyurethane polymers with polyurethane backbones, wherein the polyurethane particles include multiple pendant groups independently attached to one or multiple polyurethane backbones within the blend of polyurethane polymers, wherein the multiple pendant groups of the polyurethane particles include polyalkylene oxides, aliphatic phosphonium salts, and epoxides; and
drying the multi-functional polyurethane coating composition to remove water therefrom on the print media substrate to leave an ink-receiving layer thereon.

15. The method of claim 14, wherein one or multiple polyurethane backbones of the polyurethane blend include polymeric portions that bridge urethane linkage groups, and wherein the urethane linkage groups are formed by reacting a polyol of the polymeric portions with 2,2,4-trimethylhexane-1,6-diisocyanate; 2,4,4-trimethylhexane-1,6-diisocyanate; hexamethylene diisocyanate; methylene diphenyl diisocyanate; isophorone diisocyanate; 1-Isocyanato-4-[(4-isocyanatocyclohexyl)methyl]cyclohexan; or a combination thereof.
